(19) United States
(12) Patent Application Publication
(10) Pub. No.: US 2002/0158451 A1
(43) Pub. Date: Oct. 31, 2002

(54) Side gas bag, side gas bag module and method of folding a side gas bag

(75) Inventor: Bernd Nusshor, Spraitbach (DE)

Correspondence Address: TAROLLI, SUNDHEIM, COVELL, TUMMINO & SZABO L.L.P., 111 LEADER BLDG., 526 SUPERIOR AVENUE, CLEVELAND, OH, 44114-1400, US

(73) Assignee: TRW Occupant Restraint Systems GmbH & Co. KG

(21) Appl. No.: 10/128,073

(22) Filed: Apr. 23, 2002

(30) Foreign Application Priority Data
Apr. 26, 2001 (DE) 101 20 470.1

(51) Int. Cl. B60R 21/22

(52) U.S. Cl. 280/730.2

(57) ABSTRACT

An inflatable side gas bag for a vehicle occupant restraint system comprises an upper edge by means of which it can be fastened in a vehicle. The side gas bag has an upper portion adjacent the upper edge and a lower portion remote from the upper edge. In a non-inflated condition, the upper portion of the side gas bag is folded in another way as the lower portion. There is proposed a method of folding such a side gas bag, and a side gas bag module incorporating such side gas bag.

### TECHNICAL FIELD

This invention relates to an inflatable side gas bag for a vehicle occupant restraint system, a side gas bag module as well as to a method of folding such side gas bag.

### BACKGROUND OF THE INVENTION

DE 200 07 141 shows a side gas bag which in the non-inflated condition is accommodated in the housing of a side gas bag module in a completely zigzag-folded form. By zigzag-folding the side gas bag, an optimum opening behavior of the cladding parts is obtained at the beginning of deployment, i.e. when the side gas bag is inflated, as the zigzag folds are deployed vertically downwards and thus towards the outlet opening of the housing. In the vicinity of the side wall of a vehicle, in particular at the side windows, a more optimal deployment behavior of the side gas bag can, however, be achieved when the side gas bag is not zigzag-folded, but rolled towards the vehicle frame. In the case of a side gas bag rolled up, the opening effect on the housing and the cladding parts is, however, not optimal.

It is the object of the invention to provide a side gas bag which has a good opening effect on the side wall of the vehicle.

### BRIEF SUMMARY OF THE INVENTION

According to the invention, a side gas bag comprises an upper edge by means of which it can be fastened in a vehicle. The side gas bag has an upper portion adjacent the upper edge and a lower portion remote from the upper edge. In a non-inflated condition, the upper portion of the side gas bag is folded in another way as the lower portion. The two differently folded portions result in the expansion of the side gas bag during inflation taking place in two phases, the way of expansion in each phase being each distinguished by the way in which the corresponding portion has been folded. It can thus be achieved that in each phase of the inflation process the side gas bag adopts an optimum expansion behavior.

In accordance with the preferred embodiment of the invention, the upper portion of the side gas bag is zigzag-folded, and the lower portion is rolled up. Thus, the side gas bag expands vertically downwards during inflation in the first phase as a result of being zigzag-folded, so that the opening effect on the cladding parts, for instance the roof liner, which cover the gas bag towards the vehicle interior, is optimal. In the second deployment phase, however, the side gas bag unrolls along the inner surface of a vehicle side wall or the side windows, and due to the unrolling movement it is ensured that the side gas bag does not swing into the vehicle interior.

The invention furthermore provides a side gas bag module comprising a housing and a side gas bag according to the invention, the side gas bag being accommodated in the housing in the non-inflated condition. The upper portion of the side gas bag may be folded such that in the first deployment phase the side gas bag moves directly towards the outlet opening of the housing. Thus, an optimum opening behavior of the housing is ensured under the lowest possible load.

The invention also provides a method of folding a side gas bag with an upper edge by means of which it can be fastened in a vehicle. In an upper portion adjacent the upper edge, the side gas bag is folded in another way as in a lower portion remote from the upper edge.

Further advantageous aspects of the invention can be taken from the sub-claims.

The invention will subsequently be described in detail with reference to a preferred embodiment.

### BRIEF DESCRIPTION OF THE DRAWING

FIG. 1 shows a cross-section through a side gas bag module according to the invention.

### DETAILED DESCRIPTION OF THE PREFERRED EMBODIMENT

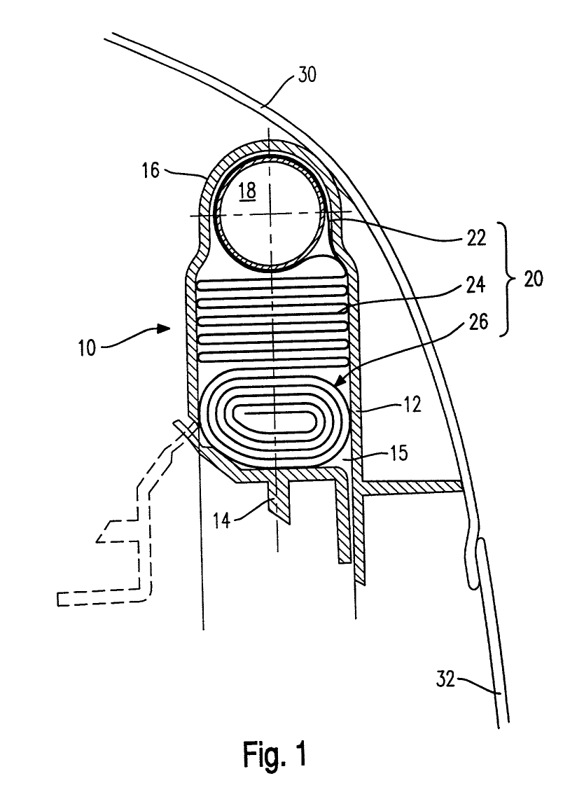

The side gas bag module 10 represented in FIG. 1 has a housing 12 with a flap 14 which closes an outlet opening 15. The upper end 16 of the housing 12 opposite the outlet opening 15 has a semicircular cross-section. Half of the upper end 16 encloses a gas lance 18 fastened in the housing 12, by means of which gas lance pressurized gas can be introduced into the housing 12. In the housing 12, there is furthermore accommodated a side gas bag 20, which has an upper edge 22, an upper portion 24 adjacent the upper edge 22, and a lower portion 26 remote from the upper edge 22. The upper edge 22 forms a loop which loops around the gas lance 18, whereby the side gas bag 20 is likewise fastened in the housing 12. The upper portion 24 is zigzag-folded, whereas the lower portion 26 next to the flap 14 is rolled up. The side gas bag module 10 is fastened in a motor vehicle, namely at the roof frame 30. The outlet opening 15 of the housing 12 points downwards towards a side wall 32 of the vehicle.

When inflating the side gas bag 20 by means of pressurized gas, which is introduced into the side gas bag via the gas lance 18, the pressurized gas first of all flows into the zigzag-folded upper portion 24. Due to the way it is folded, the upper portion 24 expands vertically downwards, so that the side gas bag 20 swivels the flap 14 into the opening position (indicated by broken lines in FIG. 1) and emerges vertically downwards through the outlet opening 15. Since the upper portion 24 expands vertically downwards, the side walls of the housing 12 experience only very small forces, so that the housing 12 can be of a correspondingly light construction. Subsequently, the lower portion 26 of the side gas bag 20 is unrolled, the lower portion 26 expanding along the side wall 32.

The lower portion 26 particularly advantageously expands along the side wall 32, when the side gas bag is rolled up such that the side of the side gas bag which in the inflated condition points towards the side wall 32 lies inside the roll, and that side which in the built-in and inflated condition of the side gas bag will point towards the inside of the vehicle forms the outside of the roll. In this case, the spin of the roll during unrolling acts towards the side wall 32 and not into the vehicle interior.

1. An inflatable side gas bag for a vehicle occupant restraint system, said side gas bag comprising an upper edge by means of which it can be fastened in a vehicle, said side gas bag having an upper portion adjacent said upper edge and a lower portion remote from said upper edge, in a non-inflated condition said upper portion of said side gas bag being folded in another way as said lower portion.

2. The side gas bag as claimed in claim 1, wherein said upper portion is zigzag-folded and said lower portion is rolled.

3. The side gas bag as claimed in claim 2, wherein said lower portion of said side gas bag is rolled up to form a roll such that a side of said side gas bag which in a built-in and inflated condition of said side gas bag will point toward an inside of said vehicle forms an outside of said roll.

4. A side gas bag module being comprised of a housing and of a side gas bag comprising an upper edge by means of which it can be fastened in a vehicle, said side gas bag having an upper portion adjacent said upper edge and a lower portion remote from said upper edge, in a non-inflated condition said upper portion of said side gas bag being folded in another way as said lower portion, said side gas bag being accommodated in said housing in a non-inflated condition.

5. A method of folding a side gas bag comprising an upper edge by means of which it can be fastened in a vehicle, in an upper portion adjacent said upper edge said side gas bag being folded in another way as in a lower portion remote from said upper edge.

6. The method as claimed in claim 5, wherein said side gas bag is zigzag-folded in said upper portion and is rolled in said lower portion.

7. The method as claimed in claim 5, wherein said lower portion of said side gas bag is rolled up to form a roll such that a side of said side gas bag which in a built-in and inflated condition of said side gas bag will point toward an inside of said vehicle forms an outside of said roll.
